(19) United States
(12) Patent Application Publication
(10) Pub. No.: US 2012/0266922 A1
(43) Pub. Date: Oct. 25, 2012

(54) Wash System for a Light Assembly

(76) Inventors: Gerardo W. Krahn, Taber (CA); Agatha Q. Krahn, Taber (CA)

(21) Appl. No.: 13/447,732

(22) Filed: Apr. 16, 2012

Related U.S. Application Data
(60) Provisional application No. 61/477,466, filed on Apr. 20, 2011.

(51) Int. Cl. B08B 3/02

(52) U.S. Cl. 134/123

(57) ABSTRACT

A wash system for the taillights of a trailer includes at least one wash nozzle directed at the taillights, a fluid supply line connected between a compressed air source and the nozzle, a wash fluid tank, and a pump which pumps a controlled amount of wash fluid from the tank into the supply line. A control valve in the supply line controllably discharges a charge of air under pressure into the supply line such that the charge of air under pressure is arranged to discharge the controlled amount of wash fluid in the fluid line through the wash nozzle. The volume of the charge of air and the amount of wash fluid are independent controlled to provide a high degree of control of the mixture of the resulting wash fluid being discharged from the nozzles to ensure effective washing of the light assemblies regardless of the conditions.

This application claims the benefit under 35 U.S.C. 119(e) of U.S. provisional application Ser. No. 61/477,466, filed Apr. 20, 2012.

### FIELD OF THE INVENTION

The present invention relates to a wash system for washing a light assembly on a wheeled frame, for example a vehicle or a trailer, and more particularly the present invention relates to a wash system in which pressurized air is used to discharge a charge of wash fluid together with the pressurized air through a nozzle directed onto the lens of the light assembly.

### BACKGROUND

As described in U.S. Pat. No. 4,248,383 by Savage et al, there are many prior art devices for cleaning vehicle windshields and/or headlamps which utilize pressurized liquid as a cleaning agent. Some of these systems include (a) the use of a chamber which is filled with a predetermined volume of liquid which is dispensed by air pressure and (b) a large liquid storage member which automatically refills the smaller chamber through a one-way valve mechanism; however, these prior art devices do not provide an escape route which permits the air in the small chamber to escape while the chamber is being refilled. Savage et al utilizes a predetermined volume delivery chamber which is automatically filled from a larger liquid reservoir together with a pneumatic delivery passage connected between the top of the delivery chamber and a liquid delivery passage which is connected to the dispensing nozzles to provide an escape route and some aspiration effect in the liquid delivery passages. The volume of liquid is fixed however such that the volume of wash liquid and/or air cannot be varied to accommodate different cleaning conditions.

United States Patent application Publication No. US2001/0054655 discloses a cleaning device which has a tank for liquid and a conveying device as well as an outlet opening. A conduit is connected to the tank and to the outlet opening. The conveying device is connected to the conduit and introduces a compressed gas into the conduit to produce a high flow velocity which draws liquid from the tank according to the venturi principle so that the cleaning medium exiting from outlet opening is a mixture of the liquid contained in the tank and the compressed gas. The venturi conveying device requires difficult calibration to be effective and does not allow the amount of cleaning fluid relative to compressed air to be readily adjusted to different cleaning conditions.

### SUMMARY OF THE INVENTION

According to one aspect of the invention there is provided a wash system for a trailer including at least one light assembly including a light source and a lens covering the light source and an air tank arranged to store air under pressure therein, the wash system comprising:

a wash nozzle associated with said at least one light assembly and arranged to be supported on the trailer so as to be directed onto the lens of said at least one light assembly;

a control valve arranged for connection to the air tank;

a fluid line in communication between the control valve and the wash nozzle associated with said at least one light assembly;

a wash fluid tank arranged to be supported on the trailer and arranged to store a wash fluid therein;

a wash line in communication between the wash fluid tank and the fluid line at a location between the control valve and the wash nozzle associated with said at least one light assembly;

a pump connected in series with the wash line;

a first controller in operative connection with the pump so as to be arranged to control pumping of a controlled amount of wash fluid from the wash fluid tank into the fluid line through the wash line; and

a second controller in operative connection with the control valve so as to be arranged to controllably discharge a charge of air under pressure from the tank through the control valve and into the fluid line such that the charge of air under pressure is arranged to discharge the controlled amount of wash fluid in the fluid line through the wash nozzle associated with said at least one light assembly;

the first and second controllers being arranged to be triggered by an operator of a towing vehicle in connection to the trailer.

The use of a pump allows for precise control of the amount of wash fluid in a manner which is unseen in the prior art. Furthermore, the use of first and second controls for separately controlling the amount of wash fluid and the amount of pressurized air charged into the fluid line provides a high degree of control of the mixture of the resulting wash fluid being discharged from the nozzles to ensure effective washing of the light assemblies regardless of the conditions.

Preferably a check valve is mounted in series with the wash line adjacent to the fluid line.

Preferably the wash line is connected to the fluid line at a location nearer to the control valve than the nozzle associated with said at least one light assembly, and more preferably adjacent to the control valve.

Preferably the first controller comprises a toggle switch biased towards an off position of the pump and the second controller comprises a toggle switch biased towards a closed position of the control valve.

The first and second controllers may correspond to opposing poles of a multi-position toggle switch in which the toggle switch is biased towards a central neutral position corresponding to the pump being off and the control valve being closed.

Preferably an inlet line is provided in communication between the wash fluid tank and a remotely located filling chamber.

When the trailer comprises a plurality of light assemblies, preferably the wash system comprises a wash nozzle associated with each light assembly and a manifold assembly arranged to substantially evenly distribute the wash fluid among the wash nozzles.

Preferably the nozzle associated with said at least one light assembly comprises a nozzle opening arranged to spray the wash fluid therefrom in a flat fan pattern spanning across the lens of said at least one light assembly.

According to a second aspect of the present invention there is provided a wash system for a trailer including at least one light assembly including a light source and a lens covering the light source and an air tank arranged to store air under pressure therein, the wash system comprising:

a wash nozzle associated with said at least one light assembly and arranged to be supported on the trailer so as to be directed onto the lens of said at least one light assembly;

a control valve arranged for connection to the air tank;

a fluid line in communication between the control valve and the wash nozzle associated with said at least one light assembly;

a wash fluid tank arranged to be supported on the trailer and arranged to store a wash fluid therein;

a wash line in communication between the wash fluid tank and the fluid line at a location between the control valve and the wash nozzle associated with said at least one light assembly;

a dispensing mechanism in series with the wash line so as to be arranged to dispense a controlled amount of wash fluid from the wash fluid tank into the fluid line through the wash line; and

a controller in operative connection with the control valve so as to be arranged to controllably discharge a charge of air under pressure from the tank through the control valve and into the fluid line such that the charge of air under pressure is arranged to discharge the controlled amount of wash fluid in the fluid line through the wash nozzle associated with said at least one light assembly;

the nozzle associated with said at least one light assembly comprising a nozzle opening arranged to spray the wash fluid therefrom in a flat fan pattern spanning across the lens of said at least one light assembly.

The flat fan pattern of the nozzle allows a single nozzle to be associated with each light assembly lens. The primary direction of the spray pattern can be oriented downward at a laterally outward inclination to ensure that dirt or debris removed from the lens of the light assembly is directed downwardly and outwardly from the trailer and other light assemblies on the trailer.

Preferably the nozzle opening of the nozzle associated with said at least one light assembly is arranged such that the flat fan pattern is inclined downwardly towards the lens of the light assembly. More preferably the flat fan pattern is inclined towards the lens at an angle of less than 3 degrees.

The nozzle may comprise a substantially cylindrical body locating an inlet passage coaxially therein in which the nozzle opening comprises a slot in the body extending radially outward from the inlet passage, substantially perpendicularly to an axial direction of the substantially cylindrical body.

Preferably the nozzle opening is arranged to be oriented such that a primary direction of the spray pattern extends downward at a laterally outward inclination.

One embodiment of the invention will now be described in conjunction with the accompanying drawings in which:

### BRIEF DESCRIPTION OF THE DRAWINGS

FIG. 1 is a rear view of a plurality of taillight assemblies on a rear end of a highway transport trailer supporting nozzles of the wash assembly associated therewith;

FIG. 2 is a schematic representation of the fluid delivery system communicating between the wash tank, the pressurized air tank and the nozzles of the wash system;

FIG. 3 is a schematic representation of the electrical components of the wash system;

FIG. 4 is an overall schematic representation of the wash system;

FIG. 5 is an inner end view of one of the nozzles;

FIG. 6 is a sectional view of the nozzle along the line 6-6 of FIG. 5;

FIG. 7 is an elevational view of an underside of the nozzle; and

FIG. 8 is a sectional view of the nozzle along the line 8-8 of FIG. 7.

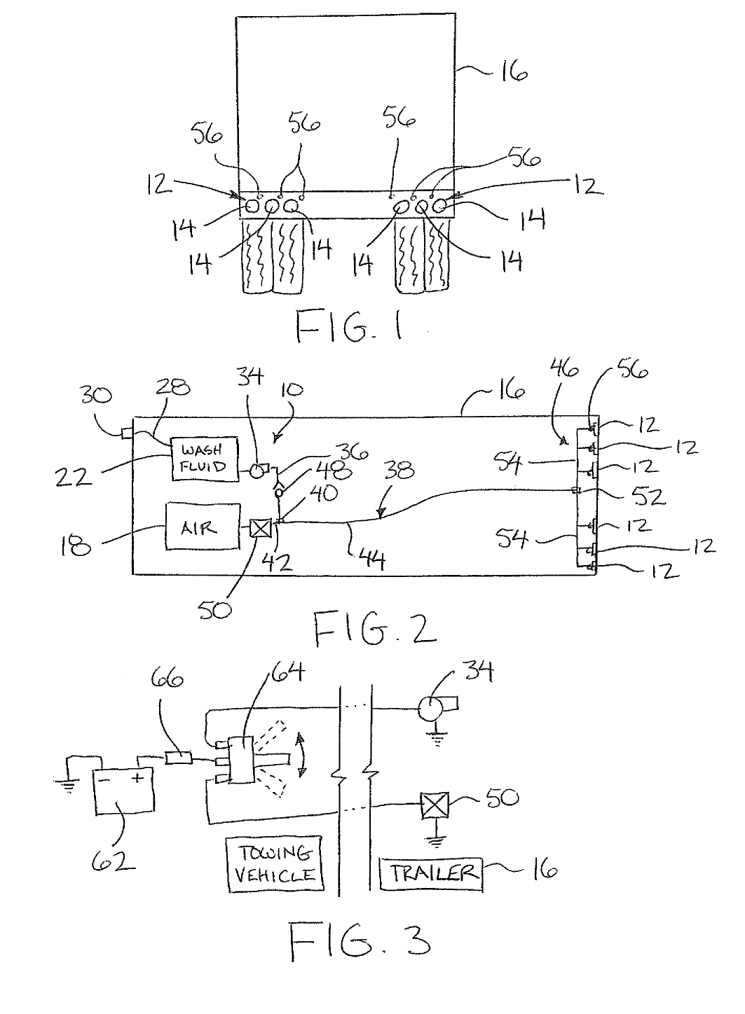

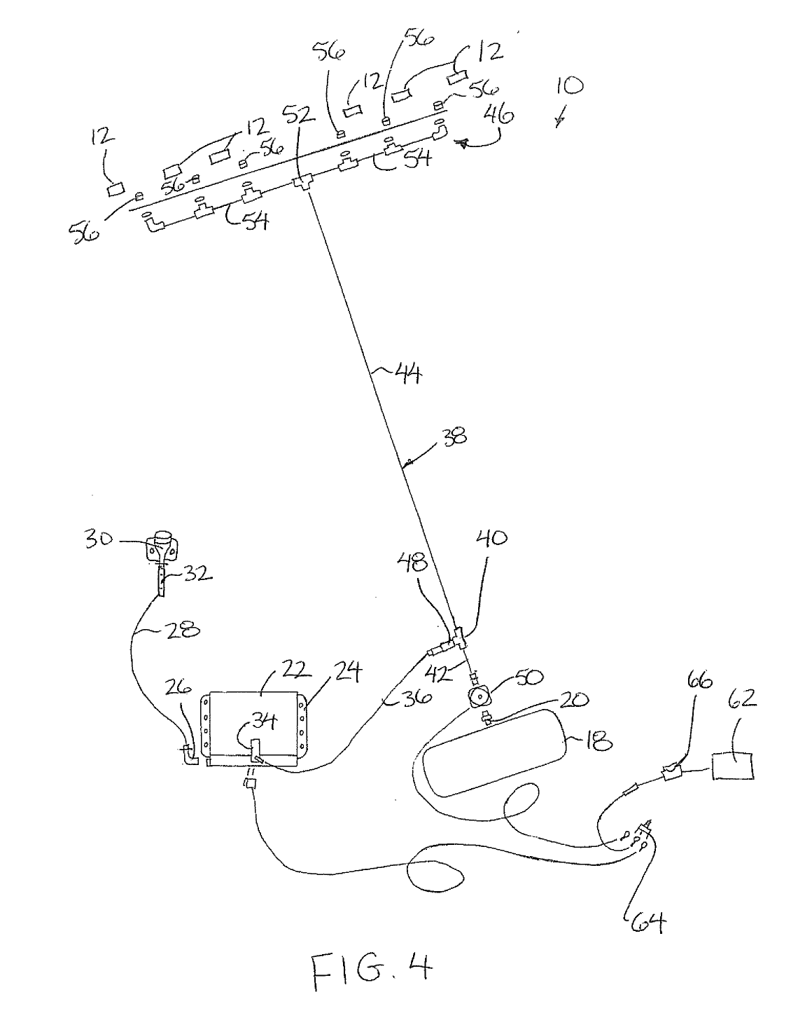

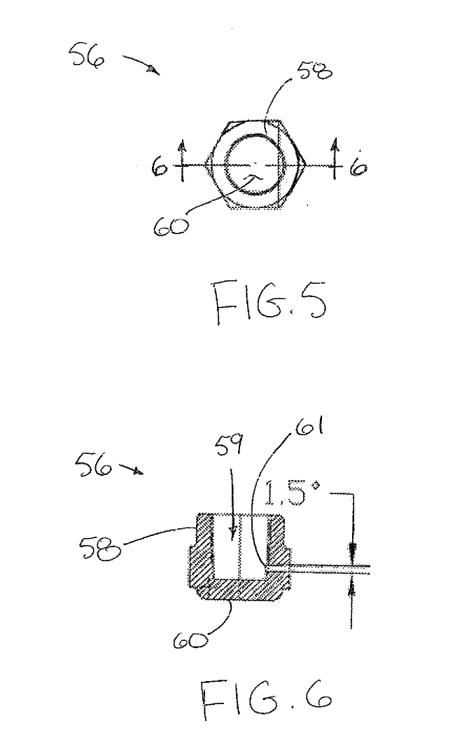

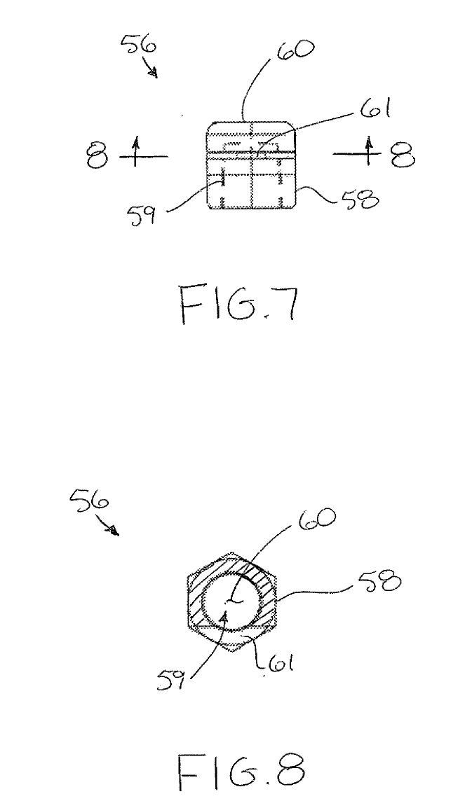

In the drawings like characters of reference indicate corresponding parts in the different figures.

### DETAILED DESCRIPTION

Referring to the accompanying figures, there is illustrated a wash system generally indicated by reference numeral 10. The system 10 is particularly suited for use with light assemblies 12 including a light source mounted within a housing supporting a lens 14 thereon through which the light from the light source is emitted. The assemblies can be mounted on various wheeled frames, for example vehicles or a trailer 16 as shown in the illustrated embodiment.

The trailer 16 is a conventional trailer for highway transport including a frame supported on wheels for rolling movement on the ground as well as a kingpin for connection to the fifth wheel of a typical highway tractor. The trailer also includes one or more air storage tanks 18 suitable for storing pressurized or compressed air therein which is typically supplied to the tank from a compressed air supply system on the towing vehicle. The air storage tanks can be used for supplying compressed air to brakes of the trailer or other equipment such as air suspension and the like. Where the trailer is provided with more than one air storage tank the wash system 10 of the present invention is typically associated with an air tank which is not associated with a brake controller of the trailer. The air tank is typically provided with a threaded plug that can be readily removed and replaced with a threaded line coupler 20 of the wash system for connection of remaining components of the wash system to the air tank.

The wash system further comprises a wash tank 22 arranged for storing a wash fluid therein. The wash tank comprises a molded plastic tank including suitable mounting flanges 24 including apertures therein suitable for receiving fasteners to attach the tank 22 in fixed relation to the frame, typically in a protected location on an interior side of frame members spanning the bottom of the trailer. The tank can be located nearer to the air tank 18 than the light assemblies.

The tank includes an inlet coupling 26 adjacent the bottom end thereof which connects to an inlet line 28 extending between the inlet coupling of the tank and a separate fill chamber 30 mounted on the trailer frame at a location remote and spaced apart from the wash tank at a higher elevation than the tank where a user has greater access for filling the wash tank with wash fluid. The fill chamber 30 similarly includes mounting flanges with apertures therein which permit fastening to the trailer. An open top end of the fill chamber is arranged to receive wash fluid therein which communicates through the inlet line into the wash tank when filling. A suitable cap encloses the open top end of the fill chamber when not in use.

The inlet line 28 can include a transparent portion 32 extending vertically downward below the fill chamber in an accessible location such that the transparent portion is at similar elevation as the tank 22. The transparent portion includes suitable graduated markings thereon which serve to indicate the fluid level in the tank due to the open fluid communication between the inlet line and the tank. The inlet line may be a hose in the order of ⅝ of an inch in diameter for example.

An outlet for the tank located at the bottom side thereof is coupled directly to a pump 34 which is arranged for pumping wash fluid out of the tank and through a wash line 36 connected to the outlet of the pump. The wash line may be a flexible hose in the order of 3/16 of an inch in diameter.

The wash line 36 couples the pump outlet to a main fluid line 38 by a T-connector 40 in series with the main fluid line such that the main fluid line is separated into a first portion 42 and a second portion 44. The first portion is a short line in the order of 6 inches in length for example which connects between the T-connector 40 and the line coupler 20 at the outlet of the air storage tank 18. The second portion 44 of the main fluid line extends longitudinally, substantially the full length of the trailer between the T-connector 40 and a manifold assembly 46 adjacent the light assembly at the rear end of the trailer.

A check valve 48 is coupled in series with the wash line 36 adjacent the T-connector 40 to prevent back flow of wash fluid from the fluid line back into the wash line once the pump has pumped the fluid in the normal working direction from the tank to the main fluid line. Due to the short section of the first portion of the main fluid line, the wash line is coupled to the fluid line adjacent to the air tank so that the wash fluid pumped into the main fluid line is pumped into the line at a location nearer to the air supply than the manifold assembly 46 adjacent the light assembly.

A control line 50 couples the first portion of the fluid line 38 to the line coupler 20 of the air storage tank 18 for controlling the discharge of compressed air from the air tank into the main fluid line. The control valve is an electric solenoid valve normally in a closed position when de-energized. Energizing the control valve 50 causes the valve to remain open while the valve remains energized such that a resulting charge of compressed air is discharged from the air tank 18 into the line. The line coupler, the control valve and the main fluid line may all include a suitable ½ inch passage therethrough.

The manifold assembly 46 at the discharge end of the main fluid line includes a main T-connector 52 for separating the main fluid line into two laterally opposed discharge lines 54. Each of the discharge lines include suitable T-connectors or elbows therein with sections of line therebetween for evenly distributing fluid from the main fluid line 38 to a series of nozzles 56 in which each nozzle is associated with its own respective light assembly of the trailer.

Each nozzle 56 is mounted in a fixed relation onto the frame of the trailer at a location spaced upwardly and laterally inwardly towards a center of the trailer in relation to the associated light assembly. The nozzle opening is oriented to spray fluid discharged from the nozzle at a downward and laterally outward inclination away from the longitudinal center of the trailer to direct the spray across the rear facing surface of the light assembly lens.

Each nozzle comprises a generally cylindrical body having a coaxial passage 59 extending therethrough from an open end connected to the manifold assembly to an opposing closed rear end 60. The nozzle opening 61 comprises a slot formed in one side of the cylindrical body to extend radially inward from the outer surface to the inner passage such that the slot lies near perpendicular to the axial direction of the generally cylindrical body.

The two opposed walls of the slot are near parallel to one another and near perpendicular to the axial direction of the cylindrical body. The walls of the slot are oriented to slightly diverge from one another in the radial direction from the inner passage to the outer surface. For example, the wall closest to the closed end may be perpendicular to the axial direction while the wall spaced inward therefrom may be inclined by 1.5 degrees so that the width of the gap increases with increasing radial distance from the inner passage.

The depth of the slot is arranged such that the opening formed in the inner surface of the inner passage corresponds to an arc of approximately 90 degrees in the circumferential direction. In this instance the spray pattern exiting the nozzle opening corresponds to a substantially flat fan pattern which is near parallel to the lens surface across which the spray is directed but at a slight inward incline of less than a few degrees to direct the fan pattern inward in the axial direction of the passage of the nozzle back onto the rear facing lens surface.

The fan pattern is symmetrical about a central axis at the center of the arc of the opening extending radially outward from the inner passage to define a primary direction of the spray. The nozzles are each oriented such that the primary direction is oriented at a downward and outward inclination across the respective lens corresponding to an angle of approximately 45 degrees from vertical.

The wash system includes electrical controllers receiving power from a battery 62 of the towing vehicle typically. Operation of the system is provided by a main switch 64 arranged to be mounted in the operator cap of the towing vehicle for ready access by the operator during transport. The main switch comprises a three position toggle in which a central position corresponds to the switch being in a neutral orientation with the pump 34 being off and the solenoid control valve 50 being closed and de-energized.

Deflecting the main switch 64 in a first direction causes the switch to function as a first controller arranged to provide electrical power to the pump for turning the pump on and pumping wash fluid from the tank into the fluid line while it remains on. The length of time that the pump remains turned on thus corresponds to the amount of wash fluid dispensed into the fluid line.

When the main switch is deflected from the neutral position in a second direction opposite the first direction, the main switch acts as a second controller which provides electrical power to the control valve for energizing and opening the valve to discharge a charge of pressurized air from the air tank 18 into the fluid line. Again, the length of time that the switch remains on corresponds to the amount of compressed air discharged into the fluid line. The switch 64 is biased from both the first and second directions back to the neutral position such that in the absence of any operator manually holding the switch in one direction or another the system remains turned off.

A main pole of the main switch 64 receives electrical power from the positive terminal of the battery 62 by a suitable electrical line including a fuse 66 connected in series therewith. The first and second poles of the switch 64 corresponding to activation in the first and second directions are connected to respective power lines which are in turn connected to the positive terminals of the pump and the control valve respectively. The negative terminals of the control valve, the pump and the battery are all connected to a common ground of the trailer and towing vehicle.

In use, the operator initially triggers the main switch in the first direction for a first duration, for example in the order of 5-8 seconds such that the pump is operated to pump a controlled amount of wash fluid proportional to the activation time through the wash line and check valve into the main fluid line adjacent the inlet end coupled to the air supply tank. The user then displaces the switch into the opposing second direction for a second duration, for example five seconds, for discharging a charge of pressurized air into the inlet end of the fluid line which is proportional to the activation time of the control valve. The charge of compressed air is discharged from the tank through the control valve for mixing with the wash fluid already pumped into the fluid line such that the wash fluid is conveyed with the compressed air through the fluid line to the discharge end where the manifold assembly evenly distributes the charge of wash fluid and compressed air to the nozzles for even sprayed distribution across the respective lenses of the light assemblies for cleaning the light assemblies.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A wash system for a trailer including at least one light assembly including a light source and a lens covering the light source and an air tank arranged to store air under pressure therein, the wash system comprising:
a wash nozzle associated with said at least one light assembly and arranged to be supported on the trailer so as to be directed onto the lens of said at least one light assembly;
a control valve arranged for connection to the air tank;
a fluid line in communication between the control valve and the wash nozzle associated with said at least one light assembly;
a wash fluid tank arranged to be supported on the trailer and arranged to store a wash fluid therein;
a wash line in communication between the wash fluid tank and the fluid line at a location between the control valve and the wash nozzle associated with said at least one light assembly;
a pump connected in series with the wash line;
a first controller in operative connection with the pump so as to be arranged to control pumping of a controlled amount of wash fluid from the wash fluid tank into the fluid line through the wash line; and
a second controller in operative connection with the control valve so as to be arranged to controllably discharge a charge of air under pressure from the tank through the control valve and into the fluid line such that the charge of air under pressure is arranged to discharge the controlled amount of wash fluid in the fluid line through the wash nozzle associated with said at least one light assembly;
the first and second controllers being arranged to be triggered by an operator of a towing vehicle in connection to the trailer.

2. The wash system according to claim 1 wherein there is provided a check valve in series with the wash line.

3. The wash system according to claim 2 wherein the check valve is adjacent the fluid line.

4. The wash system according to claim 1 wherein the wash line is connected to the fluid line at a location nearer to the control valve than the nozzle associated with said at least one light assembly.

5. The wash system according to claim 4 wherein the wash line is connected to the fluid line adjacent the control valve.

6. The wash system according to claim 1 wherein the first controller comprises a toggle switch biased towards an off position of the pump.

7. The wash system according to claim 1 wherein the second controller comprises a toggle switch biased towards a closed position of the control valve.

8. The wash system according to claim 1 wherein the first and second controllers corresponding to opposing poles of a multi-position toggle switch.

9. The wash system according to claim 8 wherein the toggle switch is biased towards a central neutral position corresponding to the pump being off and the control valve being closed.

10. The wash system according to claim 1 wherein there is provided an inlet line in communication between the wash fluid tank and a remotely located filling chamber.

11. The wash system according to claim 1 for a trailer comprising a plurality of light assemblies, the wash system comprising a wash nozzle associated with each light assembly and a manifold assembly arranged to substantially evenly distribute the wash fluid among the wash nozzles.

12. The wash system according to claim 1 wherein the nozzle associated with said at least one light assembly comprises a nozzle opening arranged to spray the wash fluid therefrom in a flat fan pattern spanning across the lens of said at least one light assembly.

13. The wash system according to claim 12 wherein the nozzle opening of the nozzle associated with said at least one light assembly is arranged such that the flat fan pattern is inclined downwardly towards the lens of the light assembly.

14. The wash system according to claim 12 wherein the flat fan pattern is inclined towards the lens at an angle of less than 3 degrees.

15. The wash system according to claim 12 wherein the nozzle comprises a substantially cylindrical body locating an inlet passage coaxially therein and the nozzle opening comprises a slot in the body extending radially outward from the inlet passage, substantially perpendicularly to an axial direction of the substantially cylindrical body.

16. The wash system according to claim 12 wherein the nozzle opening is arranged to be oriented such that a primary direction of the spray pattern extends downward at a laterally outward inclination.

17. A wash system for a trailer including at least one light assembly including a light source and a lens covering the light source and an air tank arranged to store air under pressure therein, the wash system comprising:
a wash nozzle associated with said at least one light assembly and arranged to be supported on the trailer so as to be directed onto the lens of said at least one light assembly;
a control valve arranged for connection to the air tank;
a fluid line in communication between the control valve and the wash nozzle associated with said at least one light assembly;
a wash fluid tank arranged to be supported on the trailer and arranged to store a wash fluid therein;
a wash line in communication between the wash fluid tank and the fluid line at a location between the control valve and the wash nozzle associated with said at least one light assembly;
a dispensing mechanism in series with the wash line so as to be arranged to dispense a controlled amount of wash fluid from the wash fluid tank into the fluid line through the wash line; and
a controller in operative connection with the control valve so as to be arranged to controllably discharge a charge of air under pressure from the tank through the control valve and into the fluid line such that the charge of air under pressure is arranged to discharge the controlled amount of wash fluid in the fluid line through the wash nozzle associated with said at least one light assembly;
the nozzle associated with said at least one light assembly comprising a nozzle opening arranged to spray the wash fluid therefrom in a flat fan pattern spanning across the lens of said at least one light assembly.

18. The wash system according to claim 17 wherein the nozzle opening of the nozzle associated with said at least one light assembly is arranged such that the flat fan pattern is inclined downwardly towards the lens of the light assembly at an angle of less than 3 degrees.

19. The wash system according to claim 17 wherein the nozzle comprises a substantially cylindrical body locating an inlet passage coaxially therein and the nozzle opening comprises a slot in the body extending radially outward from the inlet passage, substantially perpendicularly to an axial direction of the substantially cylindrical body.

20. The wash system according to claim 17 wherein the nozzle opening is arranged to be oriented such that a primary direction of the spray pattern extends downward at a laterally outward inclination.
